(19) United States
(12) Patent Application Publication
(10) Pub. No.: US 2006/0026246 A1
(43) Pub. Date: Feb. 2, 2006

(54) System and method for authorizing delivery of E-mail and reducing spam

(76) Inventors: Keith T. Fukuhara, Belmont, CA (US); Alan S. Gin, Foster City, CA (US); Samson Cheeyeung Kwok, San Leandro, CA (US); Shane I. Sareli, Salinas, CA (US); Phillip Randolph Schlesinger, Novata, CA (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 11/177,215

(22) Filed: Jul. 8, 2005

Related U.S. Application Data
(60) Provisional application No. 60/586,897, filed on Jul. 8, 2004.

(51) Int. Cl. G06F 15/16

(52) U.S. Cl. 709/206

(57) ABSTRACT

Methods and systems for blocking, from a user's email account, emails sent by an unknown sender. In one embodiment, a method may include determining if a sender of a received email message is a trusted sender; if the sender of the received email message is not a trusted sender, administering one or more tests to the sender; and if the sender passes the one or more tests, accepting the received email message into the user's email account. The method may also include if the e-mail is from an unknown sender who fails the one or more tests, providing for deleting or blocking the email without placing the email in the user's email account.

### CROSS-REFERENCE TO RELATED APPLICATION

This application claims priority to, under 35 U.S.C. § 119(e), and is a non-provisional application of U.S. provisional patent application No. 60/586,897, filed Jul. 8, 2004, entitled “System and Method for Authorizing Delivery of E-Mail and Reducing SPAM,” the disclosure of which is hereby incorporated by reference in its entirety.

### FIELD OF THE INVENTION

This invention relates to, in general, electronic mail (e-mail), and more particularly relates to methods for reducing unwanted email.

### BACKGROUND OF THE INVENTION

Electronic mail is a critical communication tool in business and home computer usage. Electronic mail communications includes sender(s), mail gateways, mail servers, and recipients. For example, sender(s) create a message(s), targeted to a recipient. The message is transmitted to a mail gateway using a communication protocol (i.e. SMTP). The gateway then routes the mail to the appropriate mail server for the recipient. The recipient then retrieves the message from the mail server.

However, unsolicited or SPAM e-mails have increasingly become burdensome to users of e-mail accounts. These messages may contain unwanted content, advertisements, viruses, worms, and security risks (i.e. Trojan horses, malicious scripts). As recognized by the present inventors, many of these unwanted messages often originate from known Internet Addresses (IP Addresses) and/or IP Addresses that are dynamically allocated. IP Addresses with dynamically allocated addresses usually are associated with dial-up and broadband connections. Illicit senders often use dial-up and broadband links, due to the lack of security restrictions.

As recognized by the present inventors, unwanted electronic mail often have malformed formatted content. The return address may not be legitimate, may be forged to other sending servers/gateways. Often, mail servers are systematically polled to find legitimate electronic mail addresses. Patterns of searching for legitimate recipient addresses are detectable.

As recognized by the present inventors, SPAM can also be used to create Denial of Service (DOS) attacks that render electronic mail services unavailable.

Many conventional e-mail systems provide SPAM filters wherein e-mails that contain certain content or certain words (such as sexually explicit language) are heuristically judged to be SPAM e-mails and placed in a folder of SPAM mail or list of potential SPAM mail. These filter systems generally require that the user review the list of SPAM mail or the mail contained within the SPAM folder and that the user manually deletes the e-mail that is in fact SPAM e-mail (or extracts from the list or folder the legitimate e-mail that was improperly identified as SPAM e-mail). One problem with such systems is that non-SPAM email may be improperly identified as SPAM. Further, in either of these systems, the e-mail system must store the SPAM e-mail until the user has a sufficient amount of time to review and delete the e-mails that are in fact SPAM e-mails.

As recognized by the inventors, what is needed is a system and method that filters unauthorized electronic mail to be filtered, and authorized electronic mail to be forwarded to a highly available mail gateway or server.

It is against this background that various embodiments of the present invention were developed.

### SUMMARY

In light of the above and according to one broad aspect of one embodiment of the present invention, disclosed herein is a method for blocking, from a user's email account, e-mails that come from an unknown sender.

In one example, the method includes providing for the user to identify one or more approved senders, and providing for the unknown sender to become an approved sender if the unknown sender passes one or more tests.

The operation of providing for the user to identify one or more approved senders may include providing a list of approved email addresses. The operation of providing for the user to identify one or more approved senders may includes providing a list of email addresses that can be approved by the user. The one or more tests may include a CAPTCHA test, a test that asks for confidential information, a test that asks for security information, or any other test for identifying SPAM or unwanted email.

The method may also include if the e-mail is from an unknown sender who fails the one or more tests, providing for deleting or blocking the email without placing the email in the user's email account. In another example, the method may also include if the e-mail is from an unknown sender who does not pass the one or more tests within a predetermined amount of time, providing for blocking the email from the user's email account. In another embodiment, the method may also include if the e-mail is from an unknown sender who passes the one or more tests, providing for placing the email in the user's email account.

According to another broad aspect of another embodiment of the present invention, disclosed herein is a method for blocking, from a user's email account, emails sent by an unknown sender. In one example, the method may include determining if a sender of a received email message is a trusted sender; if the sender of the received email message is not a trusted sender, administering one or more tests to the sender; and if the sender passes the one or more tests, accepting the received email message into the user's email account.

In one embodiment, the determining operation may include providing a list of approved email addresses, and determining whether an email address of the sender is in the list of approved email addresses. In one example, if the sender fails the one or more tests, the received email message is deleted or blocked without placing the email in the user's email account.

Embodiments of the invention may also be implemented in a computer program product, such as a CD-ROM, or provided as part of an email application program or server.

The foregoing and other features, utilities and advantages of the invention will be apparent from the following more particular description of various embodiments of the invention as illustrated in the accompanying drawings and claims.

### BRIEF DESCRIPTION OF THE DRAWINGS

FIG. 1 illustrates an example of a computer display screen/user interface including a list of trusted email addresses, a list of un-trusted/guest email addresses, and a list of email addresses to be blocked, in accordance with one embodiment of the present invention.

FIG. 2 illustrates an example of a computer display screen/email message for sending to an unknown sender including a link to a test, in accordance with one embodiment of the present invention.

FIG. 3 illustrates an example of a computer display screen/graphical user interface including a test for an unknown sender to complete, in accordance with one embodiment of the present invention.

FIG. 4 illustrates an example of a computer display screen/email message for sending upon an unknown sender successfully passing a test, in accordance with one embodiment of the present invention.

FIG. 5 illustrates an example of a computer display screen/user interface including a list of trusted email addresses, a list of un-trusted/guest email addresses, and a list of email addresses to be blocked, in accordance with one embodiment of the present invention.

FIG. 6 illustrates an example of a computer display screen/user interface including a list of trusted email addresses, a list of un-trusted/guest email addresses, and a list of email addresses to be blocked, in accordance with one embodiment of the present invention.

FIG. 7 illustrates an example of a computer display screen/user interface including a control for a user to select whether to automatically or manually approve an unknown sender if that unknown sender successfully passes the tests, in accordance with one embodiment of the present invention.

FIG. 8 illustrates an example of a computer display screen/user interface including controls for a user to select whether to accept or reject an unknown sender that has successfully passed the tests, in accordance with one embodiment of the present invention.

FIG. 9 illustrates an example of a computer display screen/email message for sending to a sender that the user has placed on the blocked list, in accordance with one embodiment of the present invention.

FIG. 10 illustrates an example of logical operations for processing emails received, in accordance with one embodiment of the present invention.

FIG. 11 illustrates a block diagram of an example of a delivery approval management (DAM) system, in accordance with one embodiment of the present invention.

FIG. 12 illustrates a flow diagram of one example of a process for electronic mail authorization and data references, in accordance with an embodiment of the present invention.

FIG. 13 illustrates a flow diagram of an example of a process for filtering of unauthorized IP addresses, unauthorized senders, and malformed messages, in accordance with one embodiment of the present invention.

FIG. 14 illustrates a flow diagram of an example of a process for challenging unknown senders, for instance a CAPTCHA test to validate that the unknown sender is a human as opposed to an automated process, in accordance with one embodiment of the present invention.

FIG. 15 illustrates a flow diagram of an example of a process to validate acceptable IP Addresses that will be accepted to the sender, including rejecting addresses from dynamically allocated IP addresses and known SPAM senders, in accordance with one embodiment of the present invention.

FIG. 16 illustrates a flow diagram of an example of a process to validate the content headers of electronic mail messages, in accordance with one embodiment of the present invention.

FIG. 17 illustrates a flow diagram of an example of a process for checking a sender's email addresses before authorizing the e-mail message, in accordance with one embodiment of the present invention.

FIG. 18 illustrates a flow diagram of an example of a process to create and recognize the temporary e-mail addresses or aliases for a user, in accordance with one embodiment of the present invention.

### DETAILED DESCRIPTION

Disclosed herein are various embodiments for providing a system and associated methods reduce the amount of spam e-mail received by an e-mail user. Further, disclosed herein are various embodiments of systems, methods, and user interfaces for permitting users to selectively approve e-mails from potentially untrusted e-mail addresses and further, if desired, to block e-mails from particular senders. Further, disclosed herein are various embodiments of systems and methods for distinguishing SPAM email generated by computers or mail servers versus non-SPAM email created by a human.

According to another embodiment of the invention, disclosed herein is a method for providing electronic mail security, by filtering unauthorized mail and only allowing authorized electronic mail to pass. In one example, the method includes providing for authorized senders to forward electronic mail to the recipient via the electronic mail gateway/server.

In another example, the method may include providing for filtering unauthorized senders from known IP Addresses of SPAM senders, and Dynamically Allocated IP Addresses (i.e. dial-up and broadband users). These unauthorized IP Addresses will be stored in a database or reference data store for lookup. If a sender's IP address is found in the database/reference data store, then a rejection of that connection is initiated.

In one example, the method may include providing for unknown/unauthorized senders to request authorization by the recipient to allow incoming mail to be accepted. In one example, a test may be used including a “Completely Automated Public Turing test to tell Computers and Humans Apart” (CAPTCHA) test. This test provides a challenge graphical or otherwise that would require human intervention to pass a dynamic test to validate that the test was passed by a human and not an automated process by a machine.

In another example, the method may include providing for a recipient to register authorized/known senders to send electronic mail to a recipient. This operation can be automatic or manual. If automatic, the CAPTCHA test would be utilized, and the sender's electronic mail address would be automatically added to an acceptable senders list. If manual, the recipient would be requested to manually accept the message prior to delivery to the recipient.

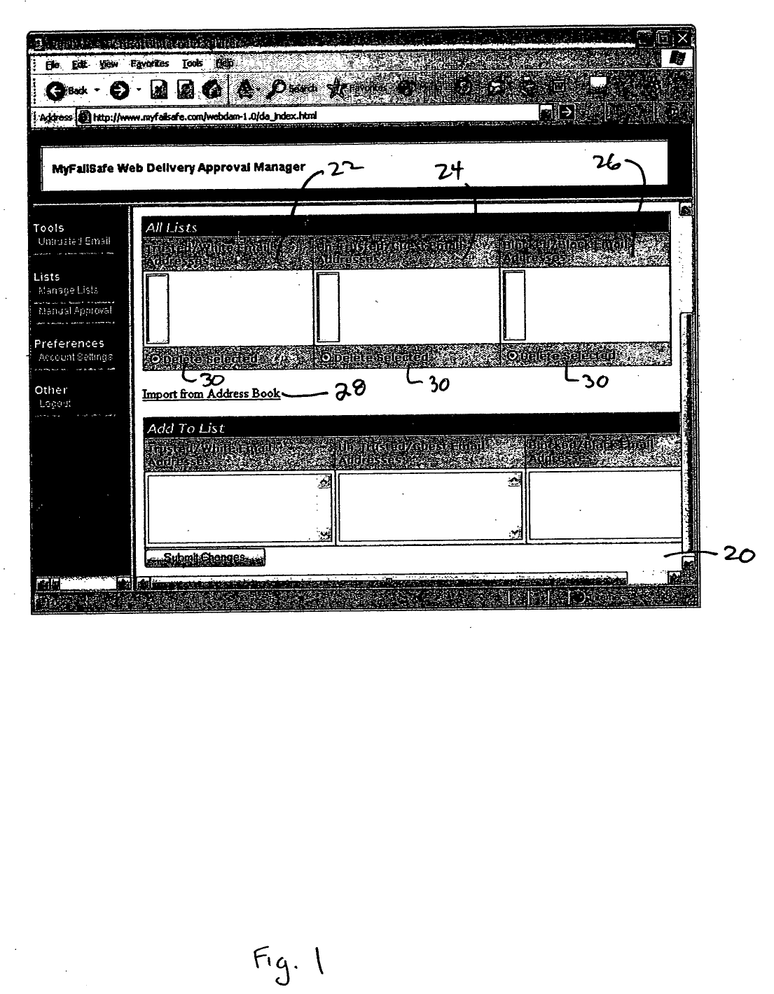

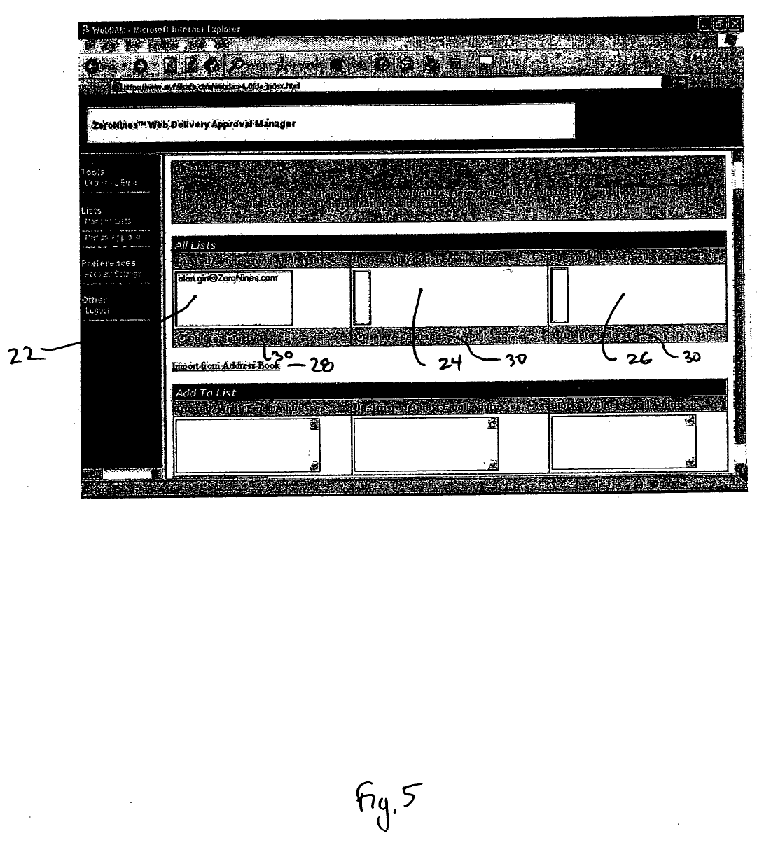

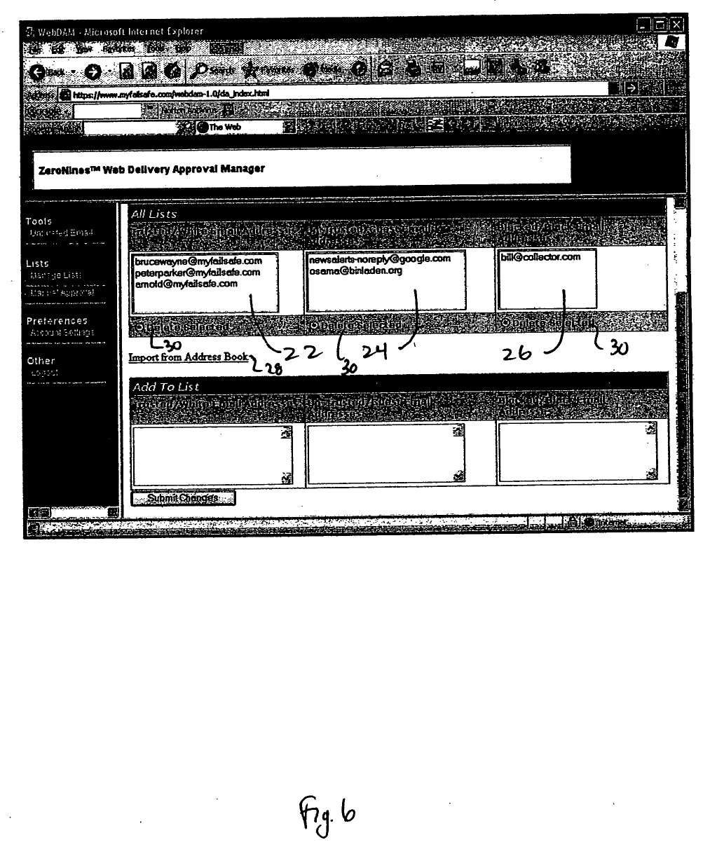

FIG. 1 illustrates an example display screen of a user interface 20. In one example, a user interface 20 may include a list 22 of approved or trusted e-mail addresses, a list 24 of untrusted e-mail addresses, and a list 6 of blocked e-mail addresses. This is also shown in FIGS. 5-6. Further, a link or control 28 can be provided so that a number of addresses can be added or imported from an address book into the trusted e-mail address list 22. In one example, if the user selects or activates this control 28, then the e-mail addresses from an address book can be imported, either individually or in batch form, from an address book to the trusted e-mail address list 22.

Further, the user interface may also provide a control or button 30 for the user to selectively delete particular e-mail addresses from particular lists displayed in FIGS. 1, 5-6.

In one example, the list 22 of trusted e-mail addresses includes e-mail addresses that the e-mail program will automatically accept and place into the user's inbox.

The list 24 of untrusted or guest e-mail addresses may include the e-mail addresses of entities that have sent the user an e-mail but that have not been approved by the user or the computer program. In one example, e-mail from an unknown sender or guest may be authorized by a user explicitly if the user places the unknown e-mail address into the list 22 of trusted e-mail addresses. Further, e-mails from an untrusted, unknown, or guest may also be accepted by the e-mail program if the sender successfully passes one or more tests that may be required of the sender. In one example, the list 24 of untrusted/guest addresses includes the e-mail addresses of unknown senders who have passed the one or more required tests.

In one example, the senders that have e-mail addresses listed in the list 22 of trusted e-mail addresses are not asked to pass the one or more tests.

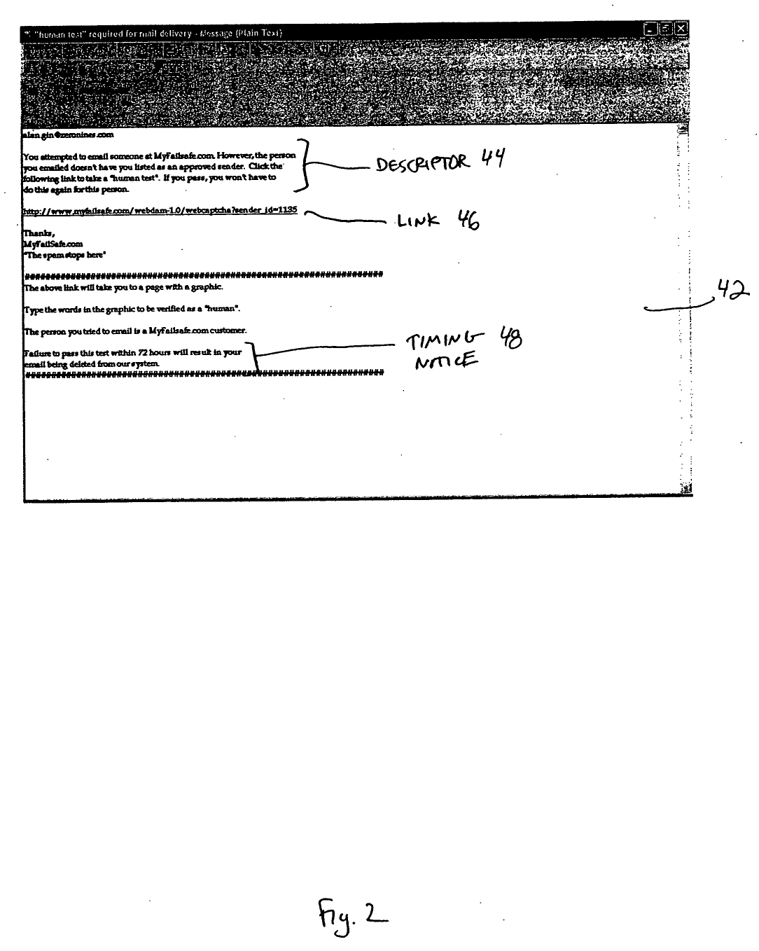

In one example, a challenge-response test 40 is used to determine whether the sender is a human, as opposed to a computer which may just be generating unsolicited SPAM e-mails. In one example, the test 40 may be a completely automated public turing test to tell computers and humans apart (CAPTCHA) utilized and required of the unknown sender before e-mail from the unknown sender will be accepted into the user's account. In one example, an e-mail 42 such as the example provided in FIG. 2 may be sent to the unknown sender, wherein this e-mail requests that the unknown sender pass the CAPTCHA test.

As shown in FIG. 2, the e-mail 42 may contain a descriptor 44, a link 46, and a timing notice 48. In one example, the descriptor 44 indicates to the unknown sender that the unknown sender is not an approved sender, and in order to become an approved sender, the sender must pass a test which is located or accessible via the link provided in the e-mail. The link 46 may be a link to a website which contains a test which may have one or more conditions that the sender must satisfy before the send will become an approved sender. The timing notice 48 may be provided in the e-mail 42, wherein the timing notice 48 indicates that the sender has a particular time period in which to pass the test, otherwise the unknown sender's e-mail will be deleted from the user's e-mail system.

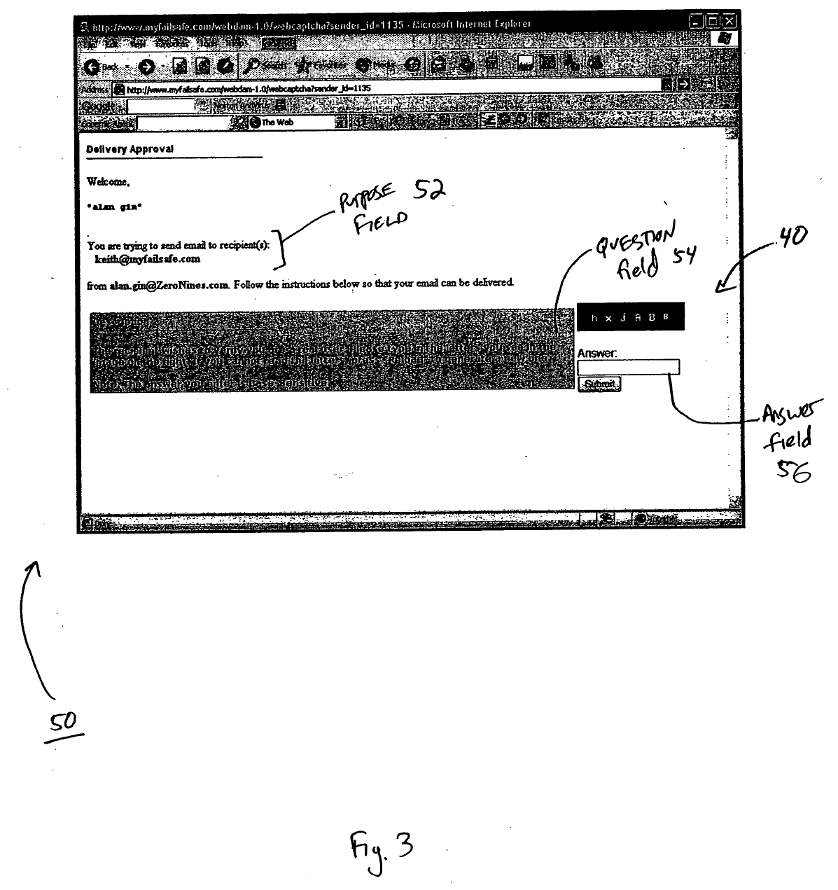

Upon the unknown sender activating the link 46 in FIG. 2, the unknown sender is then directed to one or more tests 40, an example of which is shown in FIG. 3. In FIG. 3, the unknown sender is asked to pass a test 40 which may include one or more questions required for the unknown sender to become an approved sender. These questions may include, for instance, questions that distinguish the sender from a computer, such as a CAPTCHA test, questions that require particularized knowledge, such as confidential information or other security clearances, if desired.

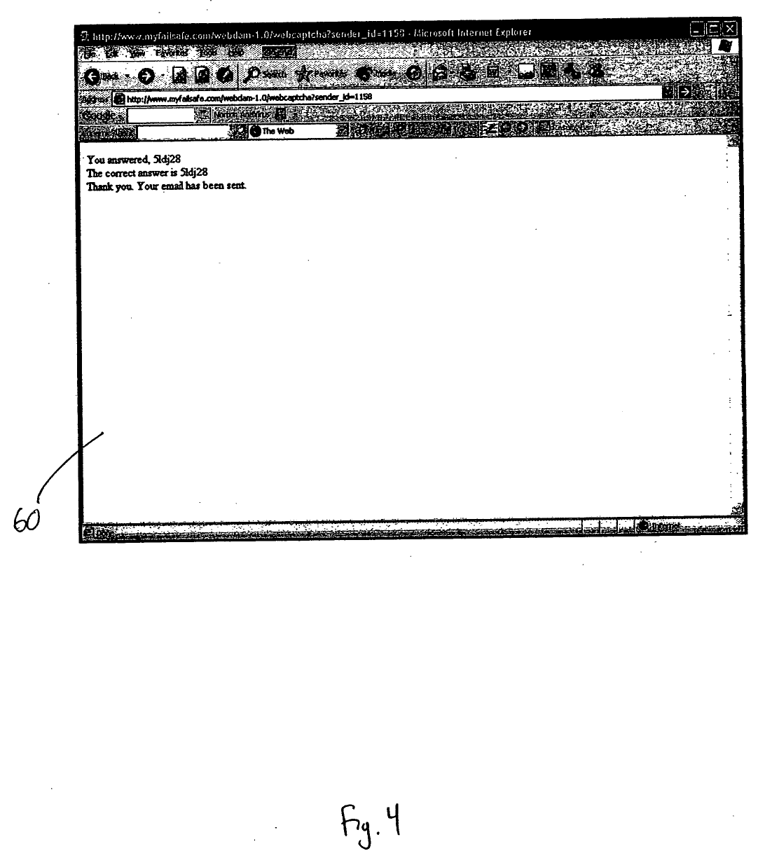

In the example of FIG. 3, the user interface 50 for the unknown sender includes a purpose field 52 which describes the purpose of the test which the unknown sender is required to take; a question field 54 which indicates the question that the user must answer; and an answer field 56 in which the unknown sender enters and submits the answer to the corresponding question 54. In one example, once the unknown sender submits the answer in the answer field 56, a second display 60 may be provided to the unknown sender which indicates that the unknown sender has successfully passed the one or more tests required, and that the e-mail of the unknown sender has been transmitted to the user. One example of such a message or display screen is illustrated in FIG. 4.

In one example, the one or more tests 40 required of an unknown sender are designed to be simple tests that a human could easily pass so that the test distinguishes the unknown sender from a computing device that automatically sends e-mail to random e-mail addresses.

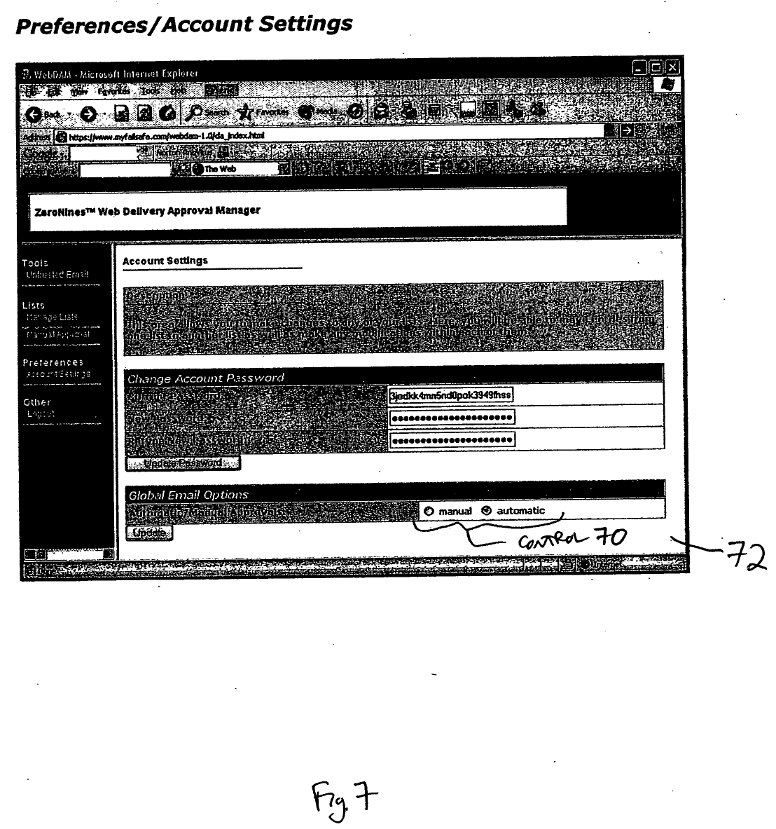

In one example, and as shown in FIG. 7, a button or control 70 may be provided in a user interface 72 for a user to select automatic or manual approval of unknown senders who have successfully passed the one or more tests 40 required. In the example of FIG. 7, this control 70 is shown as a manual or automatic control that the user can select. In one example, if the user selects manual control, then for each unknown sender that successfully passes the one or more tests 40 required to become an approved sender, the e-mail system will notify the user that the unknown sender has successfully passed the one or more tests 40, places the unknown sender in the guest list 24, and permits the user to manually select whether the unknown sender should be approved and placed in the list 22 of trusted e-mail addresses, or whether the unknown sender should be blocked. Alternatively, if the user selects the automatic control for automatic approval, then for each unknown sender that successfully passes the one or more required tests 40, the e-mail address of the unknown sender is automatically placed in the user's trusted e-mail list 22.

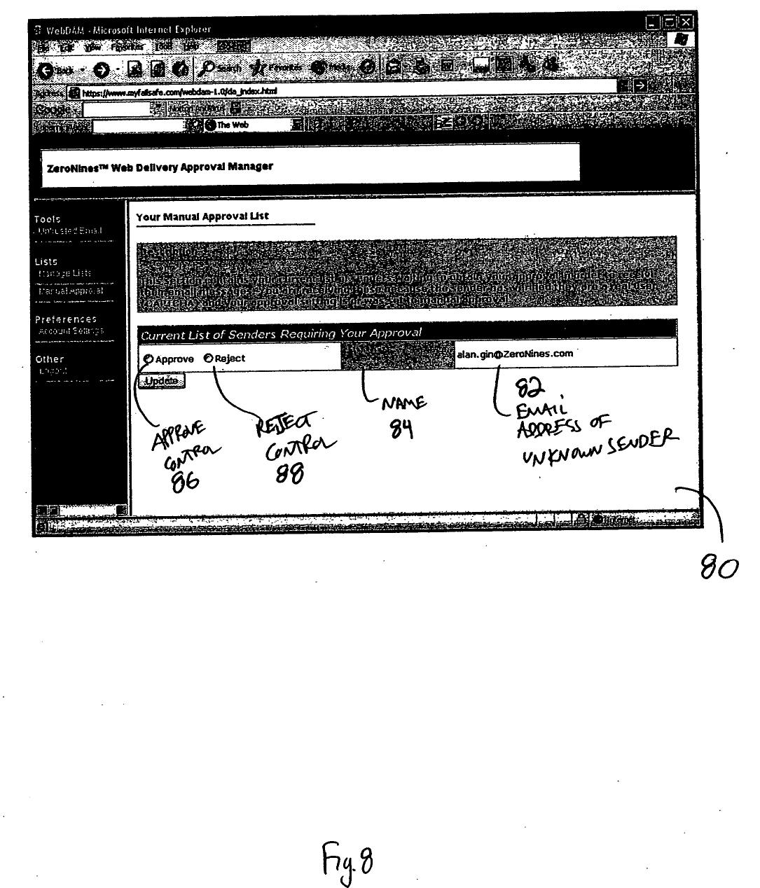

FIG. 8 illustrates an example of a display screen or user interface 80 for permitting a user to manually approve an unknown sender who has successfully passed the one or more required tests. As shown in FIG. 8, the display 80 may include the e-mail address 82 of the unknown sender, the unknown sender's e-mail name 84, if available, a control 86 for approving the unknown sender and a control 88 for rejecting the unknown sender. In one example, if the user selects the approve control 86, then the e-mail address 82 of the unknown sender is placed in the list 22 of trusted e-mail addresses and the e-mail from the unknown sender is placed in the user's inbox. If the user selects the reject control 88 in FIG. 8, then the e-mail address 82 of the unknown sender is placed in the list 26 of blocked addresses and the e-mail from the unknown sender is deleted, in one example.

The operations and functions described above with reference to various embodiments of the present invention may be integrated into an e-mail application program, or may be used in conjunction with any conventional e-mail application program.

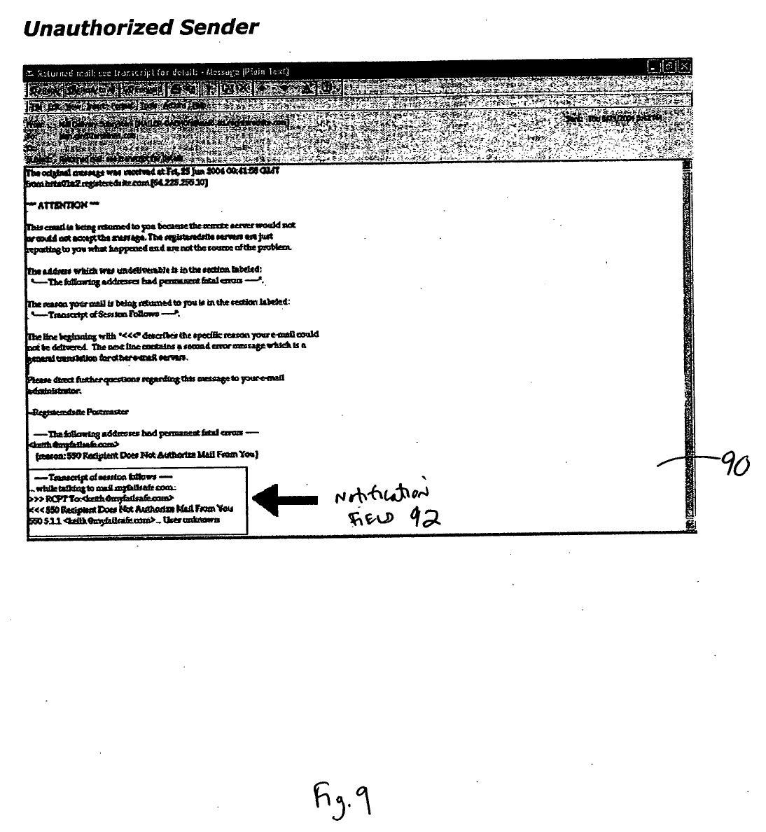

FIG. 9 illustrates an example of an e-mail message or display 90 that may be provided to an unauthorized sender. For instance, such a message may be sent to an e-mail sender that is on the user's list 26 of blocked e-mail addresses. As shown in FIG. 9, the e-mail 90 may be in the form of a returned e-mail that indicates that the e-mail from the unauthorized sender has been returned to the unauthorized sender, and may further include the reason the e-mail was returned because the recipient does not authorize receipt of mail from the unauthorized sender. As shown in FIG. 9, the e-mail may include a notification field 92 that notifies the unauthorized sender that the recipient does not accept mail from this unauthorized sender.

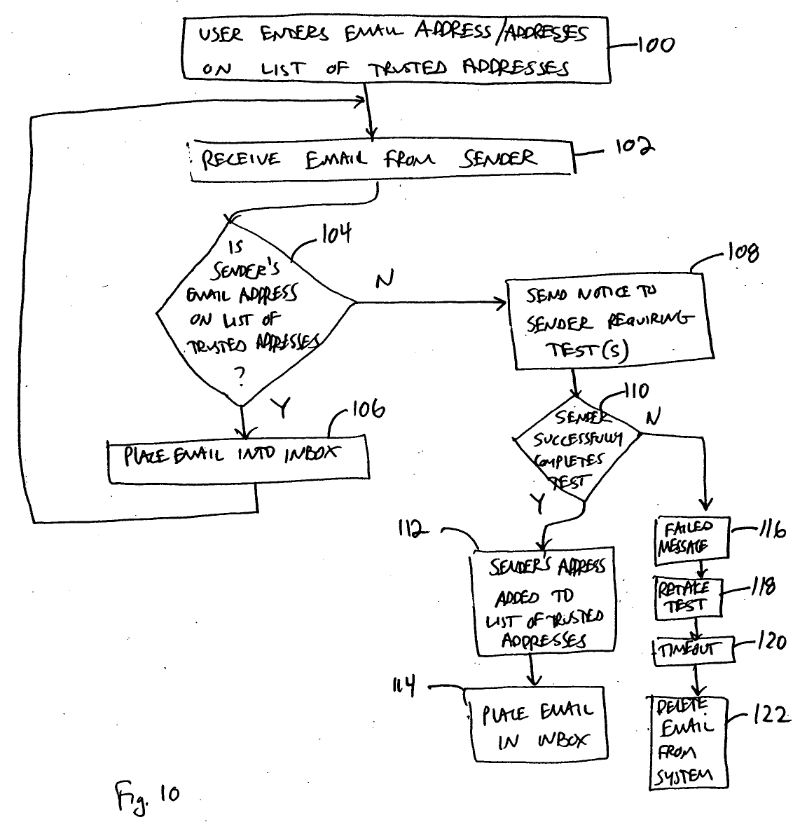

FIG. 10 illustrates an example of logical operations for processing e-mails received a user's e-mail account, in accordance with one embodiment of the present invention. At operation 100, the user enters one or more e-mail addresses into the user's list of trusted e-mail addresses. As described above, operation 100 may include the user entering individual e-mail addresses into the list of trusted e-mail addresses, or the user may enter a large number of e-mail addresses for instance through the use of an address book.

At operation 102, the user's e-mail account receives an e-mail from a sender. At operation 104, the sender's address of the e-mail received in operation 102 is compared to the list of trusted e-mail addresses of operation 100, and if there is a match, then control is passed to operation 106. At operation 106, because the sender's e-mail address was present within the user's list of trusted e-mail addresses, operation 106 places the sender's e-mail into the user's inbox. In one example, control is then returned to operation 102 for processing other new e-mails that have been received into the user's e-mail account.

However, if decision operation 104 determines that the sender's e-mail address is not on the user's list of trusted e-mail addresses, then control is passed to operation 108. In one example, operation 108 requires the sender to pass one or more tests before the sender's e-mail will be passed on to the user's inbox. In one example and as described above, operation 108 may require the sender to take a CAPTCHA test which distinguishes the sender from a computer that generates SPAM e-mail. Operation 110 determines whether the sender successfully completed the one or more tests required at operation 108, and if so, control is passed to operation 112 where the sender's e-mail address is either manually or automatically added to the user's list of trusted e-mail addresses, and at operation 114, the sender's e-mail is placed into the user's inbox.

However, if the sender fails to successfully complete the tests of operation 108, then operation 110 passes control to operations 116-122, in one example. These operations may include, for instance, sending a message to the sender that the test was failed at operation 116; permitting the sender to retake the test at operation 118, and if the sender does not successfully complete the test within 72 hours or other time period (depending upon the particular implementation) then generating a timeout at operation 120; and deleting the e-mail from the sender at operation 122 if the tests required at operation 108 are not successfully completed within the time period permitted.

Accordingly, it can be seen that embodiments of the present invention provide the user with the ability to control the senders of e-mail which the user will automatically receive and accept e-mails from, and also provide the user with the ability to completely e-mails from particular senders. As to e-mails that are sent to the user from unknown senders, embodiments of the present invention can provide one or more tests that can be utilized automatically in order to prevent the user from ever seeing SPAM e-mail in the user's inbox.

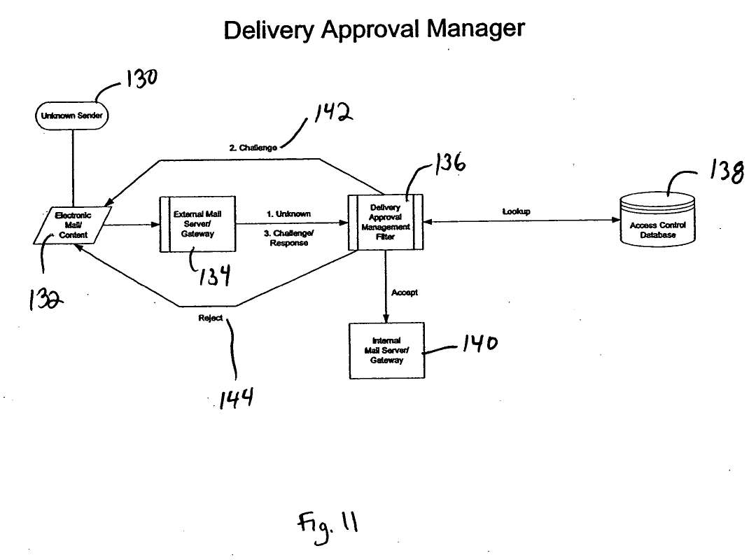

FIGS. 11-17 relate to various embodiments of a system and methods for filtering unauthorized sender's electronic mail from being delivered to a recipient. For instance, if an electronic message is sent from an unauthorized sender from a known illicit IP Address (i.e. Spammer's Address) or a dynamic address (i.e. dial up or broadband connection) is prevented from being delivered to a recipient. In one example of the invention, a Delivery Approval Manager (DAM) is provided to filter unauthorized electronic mail from entering a mail server.

Referring to FIG. 11 (Delivery Approval Manager) and in accordance with one embodiment of the present invention, an unknown sender 130 creates an electronic message 132 and sends it to an External Mail Server/Gateway 134. The External Mail Server/Gateway 134 forwards the message to the Delivery Approval Management filter or server 136. The Delivery Approval Management server 136 will reference the sender's address and message content with an Access Control Database 138.

The Access Control Database 138 tracks those senders that are authorized to send messages to a recipient. Messages originating from a known sender will be forwarded to an Internal Mail Server/Gateway 140. Unknown sender's message(s) will be challenged with one or more tests 142, such as a CAPTCHA test, limiting automated processes from sending messages to a recipient. Sender's messages will be stored temporarily for a specified period of time (i.e., 72 hours). If a sender passes a CAPTCHA test, then the message be forwarded to the recipient automatically or through a manual process controlled by the recipient. If the unknown sender is categorized as unauthorized, an entry is entered into the Access Control Database 138 for future reference.

Authorized sender messages will be forwarded to an Internal Mail Server/Gateway 140 (via a mail protocol such as SMTP). In addition, the Access Control Database 138 may implement features to track unauthorized senders and/or content signatures. Messages received from an unauthorized sender will have a corresponding rejection message 144 forwarded to the unknown sender's electronic mail account. Unauthorized messages will be deleted from the system, in one example.

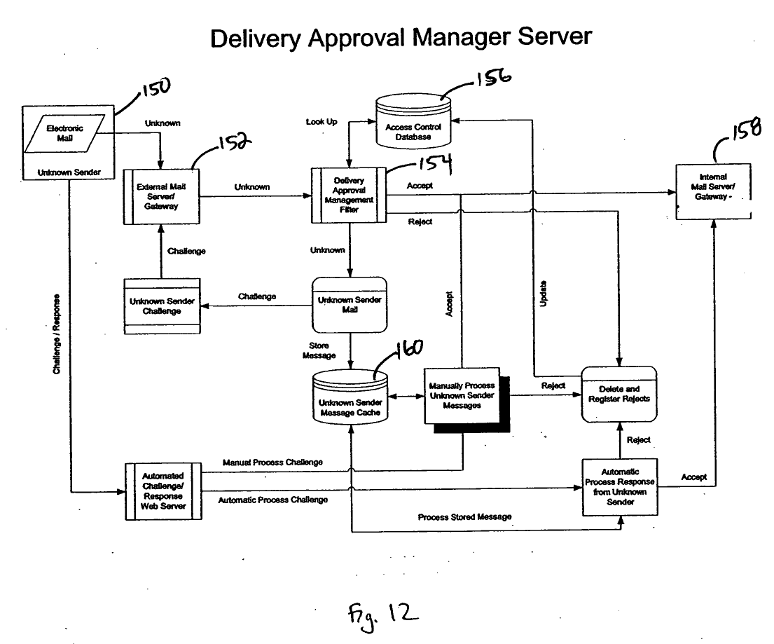

Referring to FIG. 12 (Delivery Approval Manager Server), a diagram of one example of a process for filtering unauthorized messages is illustrated, in accordance with an embodiment of the present invention. An unknown sender 150 sends an electronic message to a trusted recipient through an External Mail Server/Gateway 152. The Delivery Approval Management Filter (DAM Filter) 154 references an Access Control Database 156 for known illicit IP Addresses (i.e. Spammers, dynamically allocated IP addresses). When a connection from an illicit IP Address is encountered, the connection is immediately dropped, in one example. The Access Control Database 156 may contain illicit IP Addresses that will be authorized to continue (i.e. mail servers from legitimate domains, found in a dynamically allocated IP Address range).

The DAM Filter 154 uses the Access Control Database 156 to reference authorized senders (i.e., known senders). When a known sender is identified, the message is forwarded to the Internal Mail Server/Gateway 158 for delivery to the recipient. The DAM Filter 154 may implement different methods to identify known sender mail, for example, correct sender mail accounts and domain, pre-registered sender mail addresses, and/or properly formatted messages.

In the event that a message is from an unknown sender, the DAM Filter 154 will forward the message to a temporary cache 160, file store and/or database or other storage. A message will be generated to the unknown sender to pass one or more tests, such as a CAPTCHA test. The message from the unknown sender is stored for a limited time (days, hours or minutes—for example, 72 hours) and automatically archived or deleted if the unknown sender fails to pass the CAPTCHA test within the limited period of time. The CAPTCHA tests may include processes to identify human users by decoding graphics and or symbols.

When an unknown sender responds to the one or more test (i.e., CAPTCHA test) and passes the challenge, the message will then be processed in one of two methods, in one example. The first is a manual method, whereby recipients would log into the DAM Server and manually authorize or reject messages addressed to the recipient, if the unknown sender passed the CAPTCHA test. In the event that a message is rejected, then the electronic mail address of the rejected sender would be added to the Access Control Database 156, whereby future messages from the rejected sender would be filtered out. The second method is an automated process. Once the sender passes the CAPTCHA test, and then the electronic mail would be automatically forwarded to the Internal Mail Server/Gateway.

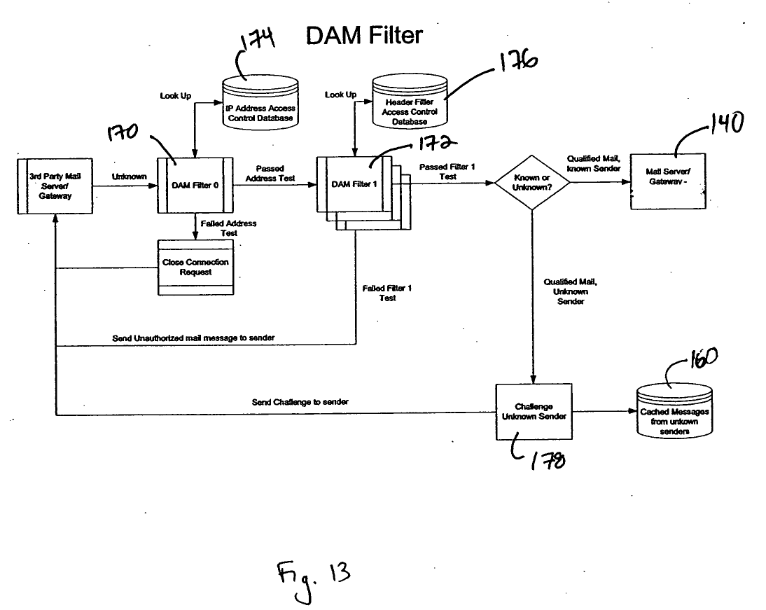

Referring to FIG. 13 (DAM Filter), a diagram of one example of a process for filtering unauthorized messages is illustrated, in accordance with an embodiment of the present invention. The DAM Filter performs the filtering of unauthorized messages. The DAM Filter may include two parts, the first is an IP Address filter 170, and the second a content based/message format filter 172.

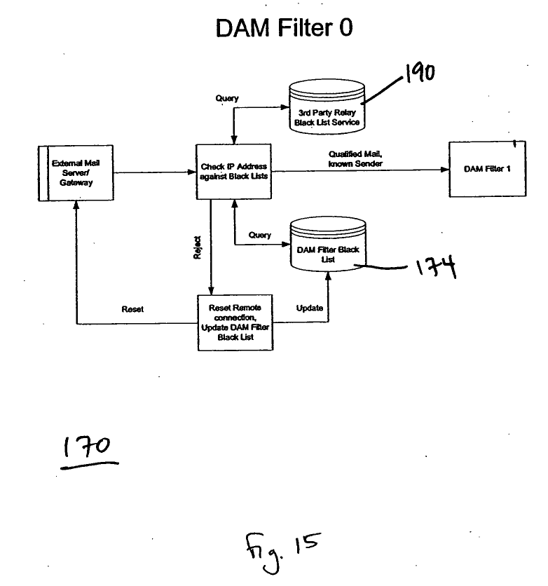

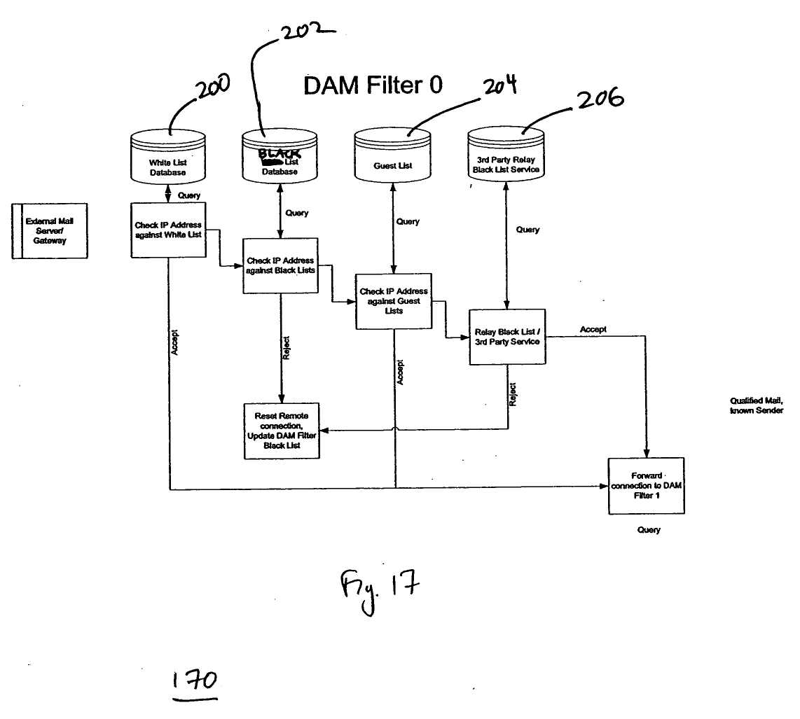

The IP Address filter 170, depicted by DAM Filter 0 (see also FIGS. 15 and 17), looks up known illicit IP Addresses from the Access Control Database (IP Address Access Control Database) 174. If an Address successfully returns, DAM Filter 0 would then determine if it is an authorized IP Address or an unauthorized address. If the IP Address connecting to the DAM Server is an authorized address, then the connection is passed to DAM Filter 1, shown as 172. If the connecting IP Address is an unauthorized address, DAM Filter 0 drops the connection, in one example.

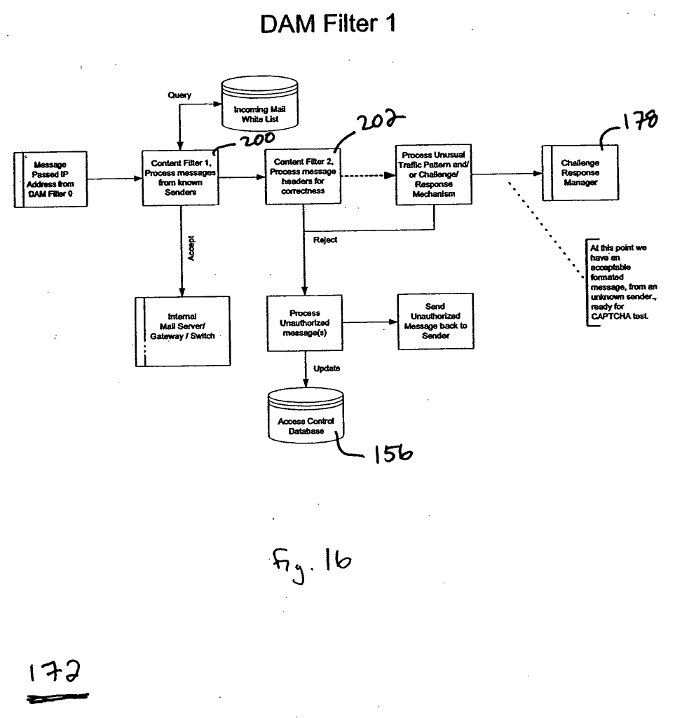

The Content Based/Message Format filter 172 (DAM Filter 1) (see also FIG. 16) may include several tests. These tests include, but are not limited to, proper recipient electronic mail addresses; authorized/unauthorized senders; properly formatted message headers; legitimate return addresses. The tests reference the Header Filter Access Control Database 176, to accept, reject or challenge message senders. If the message is from a known sender, then the mail is forwarded to the Internal Mail Server/Gateway 140.

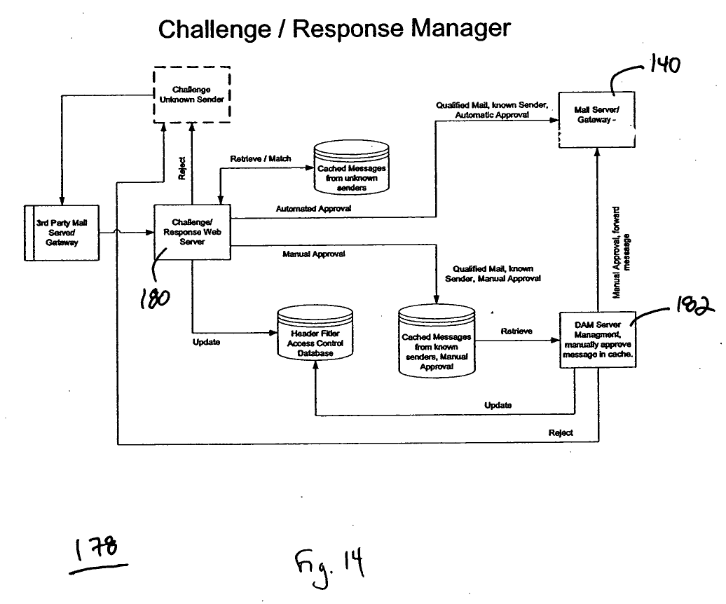

If the message is from an unknown sender, then the mail is forwarded to the Challenge Unknown Sender process (see also FIG. 14) for the tests or challenges, which may include a CAPTCHA challenge. The message would then be temporarily stored on a local cache, file store and/or database 160.

Referring to FIG. 14 (Challenge/Response Manager), a diagram of one example of a process for allowing unknown senders to register with the DAM Server is illustrated, in accordance with an embodiment of the present invention. In one example, the Challenge Unknown Sender process 178 sends an electronic mail to the unknown sender, containing information to the filtering of the message and a link to a website to allow a message to continue through the Internal Mail Server/Gateway 140.

The unknown sender links to the Challenge/Response web server 180 and must pass one or more tests, such as a CAPTCHA test. These tests can include messages stored in graphic files, sound files and/or series of questions. Once an unknown sender passes the one or more tests, the mail is forwarded to one of two destinations. If the recipient configured his/her account to automatically accept mail from unknown senders who successfully pass the tests, the unknown sender's message is forwarded to the recipient via the Internal Mail Server/Gateway 140.

In the event that the user configured his/her account to manually process messages from unknown senders that passed the tests, then the recipient would be required to enter the DAM Server management console, interface, or display 182 which may be implemented as one or more screens or displays of a graphical user interface on an email program. From the DAM Server's management interface 182, the recipient can accept addresses to be forwarded to the Internal Mail Server/Gateway 140. In the event the recipient rejects a message, the electronic mail address information contained in the message would be registered with Header Filter Access Control Database 176 (FIG. 13).

Referring to FIG. 15 (DAM Filter 0), a diagram of one example of a process for filtering unauthorized IP Address from connecting to electronic mail servers is illustrated, in accordance with an embodiment of the present invention. An unknown sender establishes a IP Based connection to the DAM Server, ready to forward mail into the Internal Mail Server/Gateway (see FIG. 12).

DAM Filter 0 performs a lookup to the local IP Address Access Control Database 174. In one example, if an address is matched, then the message would be accepted or rejected. In the event that any connection is rejected, the connecting IP Address would be entered into the IP Address Access Control Database 174. If the connection address is not found, third party services that managed lists of illicit IP Addresses 190 may be used for further reference checks. If the connecting address is still not found, then DAM Filter 0 forwards the message to DAM Filter 1.

Referring to FIG. 16 (DAM Filter 1), a diagram of one example of a process for filtering unauthorized messages based on content or format is illustrated, in accordance with an embodiment of the present invention. Messages are forwarded from DAM Filter 0, in one example. Messages may be forwarded by sending the content from DAM Filter 0 or by referencing/passing an Internet Protocol connection. The filter process may include several tests based on message format, references in the Access Control Database(s), and/or unusual traffic patterns.

In accordance with the present invention, various content filters may be implemented to filter unauthorized messages. In one example, a content filter 200 is used to determine if the recipient's address is legitimate. For each content filter the message successfully passes, the message will be allowed to continue through the filtering process.

In another example, a filter process determines if the sender's electronic mail address is an authorized address to send messages to the addressed recipient. In the event a sender's address is unauthorized address, the DAM Server would forward an unauthorized access message to the sender. In the event the sender's mail address is an authorized address referenced in the Access Control Database, the message is forwarded to the Internal Mail Server/Gateway.

In another example, a filter process 202 analyzes the message headers, validating correctness, for example: proper sender's address and/or domain; correctness in reply addresses; and/or values for timestamps or message identification strings.

If the final content filter in a series of filters has not rejected the message, it is determined that the message is legitimate, but the sender is categorized as “unknown”. The message from an unknown sender can be forwarded to the Challenge/Response Manager 178.

FIG. 17 illustrates another example of Filter 0, in accordance with one embodiment of the present invention. In this example, a filtering process determines if the sender's IP Address is on a pre-authorized list (White List) 200. If the sender's IP Address is referenced on the pre-approved list, then the connection is forwarded to DAM Filter 1. The pre-authorized list can reside in memory, disk, database or combination. If the sender's IP Address is not found on the pre-authorized list, then the connection is sent to the next filtering process, unauthorized addresses.

In another example, a filtering process determines if the sender's IP Addresses is on an unauthorized list (Black List) 202. If the sender's IP Address is referenced on the unauthorized list, then the connection is terminated and event is logged to a file. The unauthorized list can reside in memory, disk, database or combination. If the sender's IP Address is not found on the unauthorized list, then it is sent to the next filtering process, guest addresses.

In another example, a filtering process determines if the sender's IP Addresses is on a guest list 204. The guest list is used for temporary authorization of addresses that may be filtered by subsequent filtering processes. This filter allows for IP Addresses to be added on by users in an adhoc fashion. The functionality is to allow remote senders to connect even if the sender's IP Address may fall into a criteria whereby it would normally be blocked. An example would be a sender's e-mail server residing on a dynamically addressed range of IP Addresses. If the sender's IP Address is on the guest list, the connection is forwarded to DAM Filter 1. The unauthorized list can reside in memory, disk, database or combination. If the sender's IP Address is not found on the guest list, then the connection is sent to the next filtering process, Relay Black List.

In another example, a filtering process determines if the sender's IP Address is on a Relay Black List 206. Relay Black Lists contain IP Addresses of servers that have Open Mail Relay functions enabled. Open Mail Relay functions allow anonymous e-mail senders to forward mail without any security mechanisms. This allows senders who are not valid users on the e-mail server to forward messages. Relay Black Lists 206 can be built by simply testing remote systems if the Open Mail Relay function is enabled. Relay Black Lists 206 can also be licensed or subscribed as a service. The Relay Black List 206 can reside in memory, disk, database or combination. If the sender's IP Address is found on the Relay Black List, then the connection is terminated and event logged. If the sender's IP Address is not found on the Relay Black List 206, then the connection is forwarded to DAM Filter 1.

Hence, embodiments of the present invention place the burden of proof on the sender of an e-mail to prove that the sender is not an automated, SPAM generating computing device, as is so commonly used by entities that generate millions upon millions of SPAM e-mails every day.

Embodiments of the present invention may be utilized with conventional e-mail systems, or may be combined with e-mail systems that provide continuous e-mail operations such as disclosed in co-pending patent application Attorney Docket No. 33988/US entitled “SYSTEM, METHOD AND APPARATUS FOR DATA PROCESSING IN STORAGE TO PROVIDE CONTINUOUS E-MAIL OPERATIONS INDEPENDENT OF DEVICE FAILURE OR DISASTER”, filed Jul. 8, 2004, the disclosure of which is hereby incorporated by reference in its entirety.

Further, embodiments of the present invention may be combined with features disclosed in co-pending patent application Attorney Docket No. 34600/US entitled “ALIASES FOR E-MAIL ADDRESSES”, filed Jul. 8, 2004, the disclosure of which is hereby incorporated by reference in its entirety.

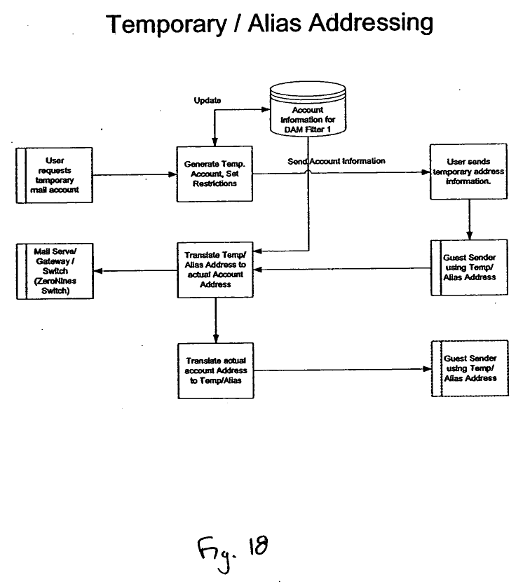

Referring to FIG. 18 (Temporary/Alias Addressing), a flow diagram of one example of a process creating temporary e-mail addresses or alias e-mail address is illustrated, in accordance with an embodiment of the present invention. In one example, temporary email addresses can be set to expire, for example as determined by number of use(s) and/or time (i.e. days, hours). Recipient/Users request a temporary mail address that will be linked through a lookup table with the recipients permanent mail address. The temporary mail address created may be a concatenation of various random strings and/or specified words from the user. Randomly generated strings may be used to enhance the overall anonymousness of the temporary mail address. For example, the recipient may concatenate a word such as “friend”. The process would generate a few letters and/or numbers in combination (such as “a8c”) and concatenate all the stings together delimited with a ‘.’ (i.e. friend.a8c.recipient@domain.com”). Generated account information is stored on the Access Control Database for translation references. When a message is received to the temporary/alias account, the DAM Server will forward the temporary/alias message to the corresponding recipient's mail address (i.e. recipient@domain.com), keeping message headers intact. A simple database table may be employed to maintain reference links between alias addresses and the actual recipient's address.

Embodiments of the invention can be embodied in a computer program product. It will be understood that a computer program product including one or more features or operations of the present invention may be created in a computer usable medium (such as a CD-ROM or other medium) having computer readable code embodied therein. The computer usable medium preferably contains a number of computer readable program code devices configured to cause a computer to affect one or more of the various functions or operations herein described.

While the methods disclosed herein have been described and shown with reference to particular operations performed in a particular order, it will be understood that these operations may be combined, sub-divided, or re-ordered to form equivalent methods without departing from the teachings of the present invention. Accordingly, unless specifically indicated herein, the order and grouping of the operations is not a limitation of the present invention.

While the invention has been particularly shown and described with reference to embodiments thereof, it will be understood by those skilled in the art that various other changes in the form and details may be made without departing from the spirit and scope of the invention.

What is claimed is:

1. A method for blocking e-mail from an unknown sender to a user's e-mail account, comprising:
providing for the user to identify one or more approved senders; and
providing for the unknown sender to become an approved sender if the unknown sender passes one or more tests.

2. The method of claim 1, wherein the operation of providing for the user to identify one or more approved senders includes providing a list of approved email addresses.

3. The method of claim 1, wherein the operation of providing for the user to identify one or more approved senders includes providing a list of email addresses that can be approved by the user.

4. The method of claim 1, wherein the one or more tests include a CAPTCHA test.

5. The method of claim 1, wherein the one or more tests include a test that asks for confidential information.

6. The method of claim 1, wherein the one or more tests include a test that asks for security information.

7. The method of claim 1, further comprising:
if the e-mail is from an unknown sender who fails the one or more tests, providing for deleting the email without placing the email in the user's email account.

8. The method of claim 1, further comprising:
if the e-mail is from an unknown sender who fails the one or more tests, providing for blocking the email from the user's email account.

9. The method of claim 1, further comprising:
if the e-mail is from an unknown sender who does not pass the one or more tests within a predetermined amount of time, providing for blocking the email from the user's email account.

10. The method of claim 1, further comprising:
if the e-mail is from an unknown sender who passes the one or more tests, providing for placing the email in the user's email account.

11. A method for blocking, from a user's email account, emails sent by an unknown sender, comprising:
determining if a sender of a received email message is a trusted sender;
if the sender of the received email message is not a trusted sender, administering one or more tests to the sender; and
if the sender passes the one or more tests, accepting the received email message into the user's email account.

12. The method of claim 11, wherein the determining operation further comprises:
providing a list of approved email addresses; and
determining whether an email address of the sender is in the list of approved email addresses.

13. The method of claim 11, wherein the one or more tests include a CAPTCHA test.

14. The method of claim 11, further comprising:
if the sender fails the one or more tests, deleting the received email message.

15. The method of claim 11, further comprising:
if the sender fails the one or more tests, deleting the received email message without placing the email in the user's email account.

16. The method of claim 11, further comprising:
if the sender fails the one or more tests, blocking the email from the user's email account.

17. A computer program product comprising a computer usable medium having computer readable code embodied therein for blocking, from a user's email account, emails sent by an unknown sender, the computer program product comprising:
computer readable program code devices configured to cause a computer to effect determining if a sender of a received email message is a trusted sender;
computer readable program code devices configured to cause a computer to effect if the sender of the received email message is not a trusted sender, administering one or more tests to the sender; and
computer readable program code devices configured to cause a computer to effect if the sender passes the one or more tests, accepting the received email message into the user's email account.

18. The computer program product of claim 17, which further comprises computer readable program code devices configured to cause a computer to effect providing a list of approved email addresses and determining whether an email address of the sender is in the list of approved email addresses.

19. The computer program product of claim 17, which further comprises computer readable program code devices configured to cause a computer to effect if the sender fails the one or more tests, deleting the received email message without placing the email in the user's email account.

20. The computer program product of claim 17, which further comprises computer readable program code devices configured to cause a computer to effect if the sender fails the one or more tests, blocking the email from the user's email account.
